(19) United States
(12) Patent Application Publication
(10) Pub. No.: US 2007/0136194 A1
(43) Pub. Date: Jun. 14, 2007

(54) Hybrid card

(76) Inventor: David Sloan, Phoenix, AZ (US)

Correspondence Address: FENWICK & WEST LLP, SILICON VALLEY CENTER, 801 CALIFORNIA STREET, MOUNTAIN VIEW, CA, 94041, US

(21) Appl. No.: 11/388,812

(22) Filed: Mar. 23, 2006

Related U.S. Application Data
(60) Provisional application No. 60/750,644, filed on Dec. 14, 2005.

(51) Int. Cl. G06Q 40/00

(52) U.S. Cl. 705/41

(57) ABSTRACT

A card-issuing financial institution provides a hybrid card for extending and building credit. The issued hybrid card has credit and debit functionality, and an account linked to the hybrid card to hold cardholder funds. The account provides security and a credit limit for extensions of credit and direct access to funds for cash withdrawals and debit transactions. Due balances are paid by electronically debiting the linked account for credit extended. Positive credit information is reported to credit bureaus.

### CROSS-REFERENCE TO RELATED APPLICATIONS

This application claims the benefit of U.S. Provisional Application Ser. No. 60/750,644, filed Dec. 14, 2005, which is incorporated herein by reference.

### BACKGROUND OF THE INVENTION

1. Field of the Invention

This invention pertains in general to credit card administration and, in particular, to administration of a hybrid card program.

2. Description of the Related Art

Convenience of use and the proliferation of the Internet have caused credit and debit cards to increasingly become the payment method of choice for everyday purchases. However, for some people, especially credit-challenged and un-banked consumers, fewer options are available for such cards and those available often are costly and provide little, if any, opportunity for credit building.

For such consumers, “subprime” credit cards—aimed at people with troubled credit—are one existing option. Subprime credit cards function much like other credit cards, but generally have lower predetermined credit limits and higher interest rates and fees. In many cases, fees charged to a subprime card upon issuance typically leave the consumer with little available credit, requiring that payments be made to free up the credit line before use. This fact, and the high interest rates and recurring fees associated with these cards, result in a high default rate for the cards, resulting in further damage to a user's credit history.

Another existing option for consumers with troubled credit are stored-value (or pre-paid) cards, which function like a regular credit card but limit purchases and cash withdrawals to the value stored on the card. These cards allow conveniences such as cash access at automated teller machines, direct deposit of payroll and government checks, and electronic bill pay. Upsides of these cards is that most people qualify for them, regardless of income or credit history, and they include direct deposit, which is not available with standard credit cards, and electronic bill pay, which is rarely available with standard credit cards. However, the downside of these cards is that no credit is extended to the card user by the card issuing bank. As a result, use of the card is not reported to credit bureaus, so these cards do not present a legitimate credit-building opportunity.

For banked consumers, debit cards exist that are linked to the consumer's checking account. However, like stored-value cards, no credit is extended for use of the card and the cards are not reported to credit bureaus, and thus no legitimate credit building opportunity exists.

Regular credit cards exist, for those who have the opportunity to use them, which provide legitimate credit opportunities. However, the cards usually come with predetermined spending limits and high fees and interest rates for cash advances, as well as stricter qualifications than subprime and stored-value cards. Existing cards offer users the option of paying a minimum payment or the balance in full, with any unpaid balance subject to an interest charge and late payments assessed a late fee. Late payments and maintaining high balances can adversely affect credit scores. As a result, these cards limit which consumers can use them and the extent to which they can be used for credit building.

A few cards exist that have attempted to combine features of different card types. For example, one existing card purports to act as both a credit card and “stored-value” card. However, this card actually is a combination credit card and vendor-specific gift card. For example, this existing card does not include functionality normally associated with a stored-value card, such as withdrawing cash at automated teller machines. In addition, a few existing stored-value cards have attempted to combine a stored-value account with a separate credit-building product, however, substantial additional fees are required for the feature. In addition, reporting and/or acceptance of the credit-building product information by credit bureaus is questionable or non-existent.

Therefore, there is a need in the art for a widely-available card that provides the benefits of secured and debit or stored-value cards while providing the credit building potential of existing credit cards.

### BRIEF SUMMARY OF THE INVENTION

The above need is met by a program and method for administering a hybrid card program for extending and building credit. In one embodiment, the method provides a financial institution-issued hybrid card that has both credit and debit functionality. An account linked to the hybrid card includes available funds that provide security and a credit limit for extensions of credit. Available funds also are available for cash withdrawals and debit transactions. Due balances for credit purchases are paid in full and on time, by electronically debiting the linked account, resulting in positive credit information being reported to credit bureaus.

### BRIEF DESCRIPTION OF THE DRAWINGS

FIG. 1 illustrates the relationship between various entities involved in a hybrid card program in accordance with one embodiment of the present invention.

FIG. 2 depicts an interaction diagram illustrating exchanges between the entities of FIG. 1 according to one embodiment of the invention.

FIG. 3 is a block diagram illustrating card-issuing financial institution software in accordance with one embodiment of the present invention.

FIG. 4 is a block diagram illustrating processor software in accordance with one embodiment of the present invention.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

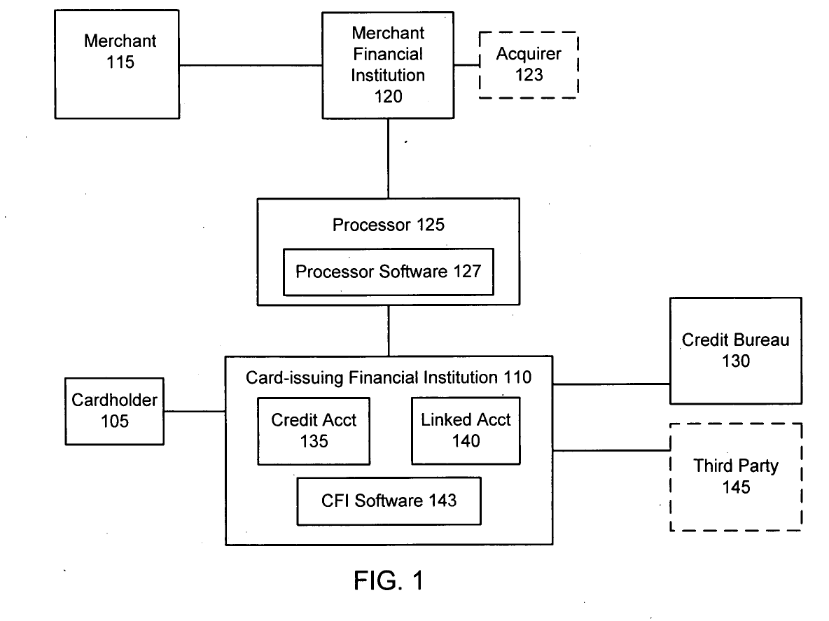

FIG. 1 illustrates the relationship between various entities involved in a hybrid card program in accordance with one embodiment of the present invention. The hybrid card program entities primarily comprise a cardholder 105, a card-issuing financial institution 110, and a credit bureau 130. When a cardholder 105 makes a purchase, e.g., via a merchant 115, a merchant financial institution 120 and a processor 125 participate. Finally, in some embodiments various third parties 145 are involved in the program.

The cardholder 105 is the user of a hybrid card as described herein, and can be, e.g., a person, a company, an entity, etc. The cardholder 105 is issued a hybrid card by a card-issuing financial institution 110 and uses the hybrid card for purchases, e.g., from merchants 115. Few qualifications are required to become a cardholder 105, because funds in the linked account 140 serve as security for extensions of credit as described herein. This is an advantage over standard credit cards, which have specific credit score and/or income requirements for card issuance.

The card-issuing financial institution 110 is a commercial bank, thrift, federal or state savings bank, saving and loan association, credit union, or other financial institution. The card-issuing financial institution 110 issues hybrid cards and establishes associated credit 135 and linked accounts 140. The hybrid card is configured for use in both credit and debit transactions. For credit transactions, the hybrid card functions as a credit card from the perspective of the cardholder 105 and the merchant 115 involved in a transaction using the hybrid card. For debit transactions, the hybrid card functions as a debit card or stored-value card from the perspective of the cardholder 105 and merchant 115 involved in a transaction using the hybrid card.

The card-issuing financial institution 110 establishes a credit account 135 and a linked account 140 associated with the hybrid card according to one embodiment. The credit account 135 is associated with use of the hybrid card for credit-type transactions and functions similar to other credit card accounts, storing credit charges up to an established credit limit. For example, upon issuance, the credit account 135 begins with a zero balance and accumulates charges as the hybrid card is used, via credit-type transactions, resulting in a negative balance. The linked account 140 is associated with use of the hybrid card for debit-type transactions. The linked account 140 is a stored-value account in the cardholder's name, which is linked to the credit account 135 and serves as security for transactions in the credit account 135 according to one embodiment. The initial linked account 140 balance represents the hybrid card's starting credit line for credit functionality, minus any applicable fees. In addition, the linked account 140 balance serves as a limit on immediate fund availability for debit functionality and direct cash withdrawals. The credit limit of the hybrid card is not predetermined according to one embodiment, but depends upon the current linked account 140 balance, or available funds, at the time of a given credit-type transaction. This aspect of the invention is an advantage over many credit cards, which have predetermined spending limits, including subprime cards, which may have very low set limits.

Future deposits to the cardholder's linked account 140, which may be made at anytime, increase the available funds that serve as the credit limit for the credit account 135 and immediate fund availability for the linked account 140. Thus, purchases, ATM withdrawals, bill payments, money transfers, transaction fees, and other debits reduce, and deposits and credits increase, the available funds, the credit limit of the hybrid card, and immediate fund availability of the linked account 140 according to one embodiment.

In one embodiment, an interest-bearing savings account is associated with the linked account 140. The savings account allows for transfers to and from the linked account 140. Funds in the savings account serve as overdraft protection in one embodiment, and if the hybrid card includes direct deposit functionality as described herein, provides additional auto-savings options such as transfers of linked account funds to the savings account, e.g., when the balance exceeds a dollar amount determined by the cardholder 105. This aspect of the invention is an advantage over cards without savings accounts, e.g., stored-value cards, because it provides a savings platform.

When a cardholder 105 makes a purchase in the form of a credit-type transaction, the card-issuing financial institution 110 verifies fund availability and freezes, or places a hold on, only the funds in the linked account 140 needed to secure actual charges (in the credit account 135), and lowers the credit limit, according to one embodiment; the remaining available balance of the linked account 140 can be used by the cardholder 105 as desired, including withdrawing the full amount in cash at an ATM or financial institution teller. This aspect of the invention provides an advantage over secured credit cards, which prevent access to security funds, even when the balance owed on the card is less than the security deposit. The hybrid card allows the cardholder 105 access to all available funds at any time.

In one embodiment, the card-issuing financial institution 110 includes a computer that is adapted to execute computer program modules. As used herein, the term “module” refers to computer program logic and/or data for providing the specified functionality. Although one embodiment described herein uses software as an example, a module can be implemented in hardware, firmware, and/or software. Thus, the card-issuing financial institution 110 computer includes card-issuing financial institution software 143, which facilitates the processes of the card-issuing financial institution 110 according to one embodiment.

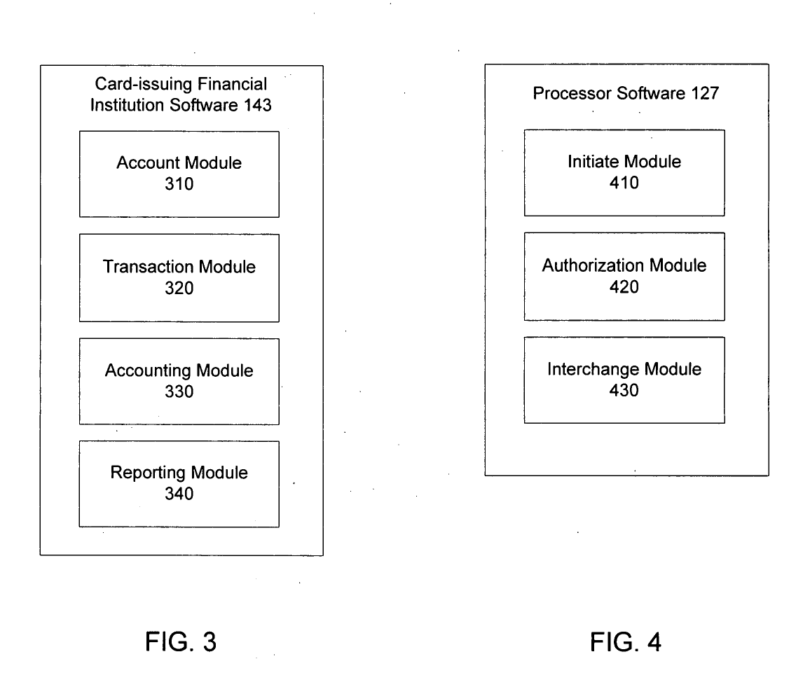

The card-issuing financial institution software 143, depicted in FIG. 3, includes an account module 310, a transaction module 320, an accounting module 330, and a reporting module 340. The account module 610 enables the card-issuing financial institution 110 to issue a hybrid card capable of both credit card functionality and debit functionality and to establish an account linked to the hybrid card with an account balance comprising the available funds for hybrid card transactions according to one embodiment.

The transaction module 320 enables the card-issuing financial institution 110 to extend credit to the user in response to the hybrid card being used as a credit card and to provide direct access to available funds in response to the hybrid card being used as a debit card according to one embodiment.

The accounting module 330 enables the card-issuing financial institution 110 to electronically debit an account linked to the hybrid card for credit-type activity and credit extended to the user during a billing period according to one embodiment.

The reporting module 340 enables the card-issuing financial institution 110 to report credit extended to a user and payment history to a credit bureau credit according to one embodiment.

The above software portions 310-340 need not be discrete software modules. The software configuration shown is meant only by way of example; other configurations are contemplated by and within the scope of the present invention.

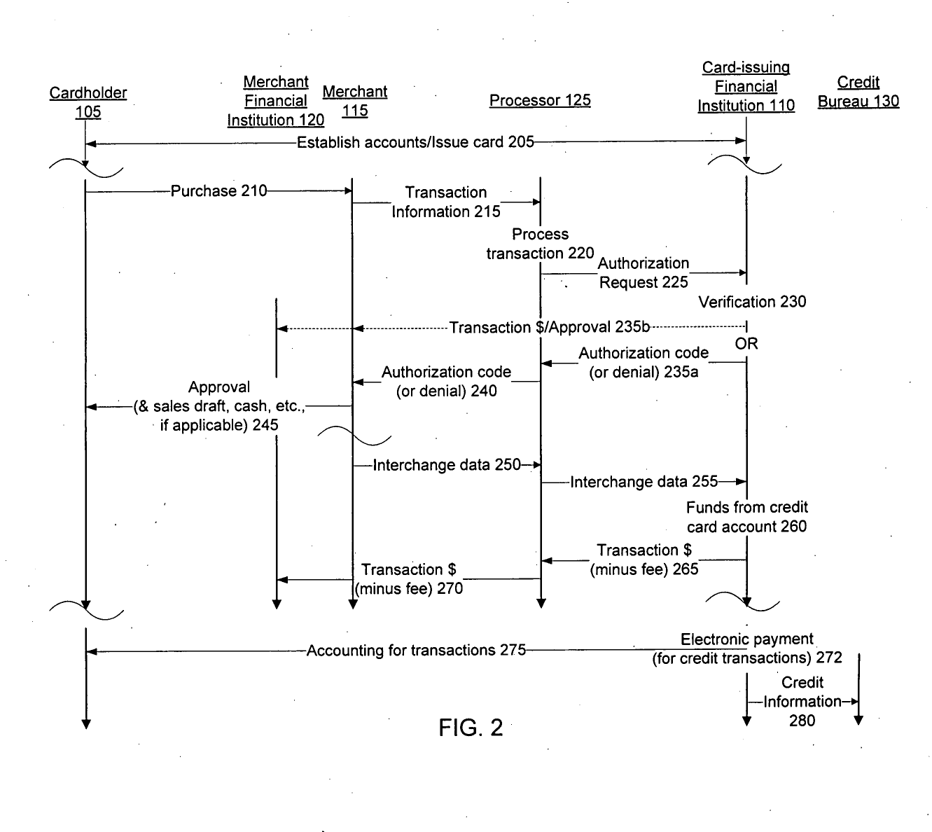

When purchases are made by the cardholder 105, one or more merchants 115 and merchant financial institutions 120 are involved. Merchants 115 are retailers or others who transact business with the cardholder 105, e.g., by providing products or services in exchange for payment by the cardholder 105 using the hybrid card. One or more merchant financial institutions 120 are financial institutions, including commercial banks, thrifts, federal and state savings banks, saving and loan associations, credit unions, or other financial institutions, associated with the merchant(s) 115, which receive funds, e.g., from a processor 125, in the merchant's accounts corresponding to transactions as described in conjunction with FIG. 2.

In one embodiment, an acquirer 123, or acquiring financial institution, is responsible for signing up the merchant 115 for credit card processing and establishes a relationship between the merchant 115 and the processor 125. The acquirer 123 is a commercial bank, thrift, federal or state savings bank, saving and loan association, credit union, or other financial institution or independent sales organization according to one embodiment. In another embodiment, the merchant financial institution 120 or processor 125 acts as the acquirer, and thus no separate acquirer is involved.

A processor 125 is an entity that handles credit card transactions, such as the transaction processing between the merchant 115 and merchant financial institution 120, and the card-issuing financial institution 110. For example, information and fund exchanges between the merchant 115 (or merchant financial institution 120) and card-issuing financial institution 110 are facilitated by the processor 125.

In one embodiment, the processor 125 includes a computer that is adapted to execute computer program modules. As used herein, the term “module” refers to computer program logic and/or data for providing the specified functionality. Although one embodiment described herein uses software as an example, a module can be implemented in hardware, firmware, and/or software. Thus, the processor 125 computer includes processor software 127 software 127, which facilitates the processes of the processor 125 according to one embodiment.

The processor software 127, depicted in FIG. 4, includes an initiate module 410, an authorization module 420, and an interchange module 430. The initiate module 410 enables the processor 125 to initiate processing of transactions by sending authorization requests to one or more financial institutions upon receipt of information indicating that a transaction involves use of a hybrid card and the transaction is a credit-type transaction according to one embodiment.

The authorization module 420 enables the processor to forward authorization codes received from one or more financial institutions to one or more merchants according to one embodiment. In this example, the authorization code is based on the financial institution having verified available funds in an account linked to the hybrid card.

The interchange module 430 enables the processor to exchange interchange funds from one or more financial institutions in exchange for data received from one or more merchants according to one embodiment. In this example, the interchange funds include funds associated with the transaction, and the funds associated with the transaction reduce the credit limit of the hybrid card. The interchange module 430 also enables deposit of interchange funds to an account associated with the merchant.

The above software portions 410-430 need not be discrete software modules. The software configuration shown is meant only by way of example; other configurations are contemplated by and within the scope of the present invention.

In one embodiment, one or more third parties 145 are associated with the card-issuing financial institution 110. For example, third parties such as employers and government agencies may associate with the card-issuing financial institution 110. This association is advantageous because it enables direct deposit of funds to the account from the third parties 145, e.g., for deposits of payroll funds, government funds, etc. associated with the cardholder 105. In this example, the card-issuing financial institution 110 also may offer the cardholder 105 overdraft protection, e.g., by deducting the amount of the overdraft, along with an overdraft fee, from the cardholder's next payroll or government benefits payment load according to one embodiment.

In another example, approved vendors may be associated with the card-issuing financial institution 110, such as administrators of a discount prescription drug and healthcare services cards or long distance calling cards. In one embodiment, prescription and healthcare discount card functionality is built into the hybrid card. The discounts are available in this example, via a network of pharmacies and other health care providers, as offered through a third-party 145, without the cardholder 105 having to pay a membership fee. In one embodiment, the hybrid card is issued with calling card functionality, including a phone number for facilitating this functionality printed on the back of the hybrid card. In this example, the hybrid card is issued with an allotment of calling time on the card at no charge to the cardholder 105. In addition, when the calling time on the card approaches a predetermined lower limit, the cardholder 105 is reminded to add value to the calling time allotment according to one embodiment.

In yet another example, an additional person is associated with the cardholder 105, and is issued a secondary card that has a separate, secondary card credit account associate with it, enabling the cardholder 105 to transfer funds between accounts, e.g., from the linked account 140 to the secondary card credit account. In this example, the cardholder 105 can make card-to-card money transfers between the accounts. In one embodiment, the secondary card is a remittance card. In yet another embodiment, the cardholder 105 can make card-to-card transfers to any other hybrid card holder with a card issued by the same financial institution.

In another example, rewards card functionality is provided in conjunction with the hybrid card, for example by offering cash back for purchases at in-store and online retailers according to one embodiment. In other embodiments, other third party 145 services are offered in conjunction with the hybrid card. These aspects of the hybrid card offering are advantageous because they provide features and services typically associated with stored-value cards, with the credit-building potential of the hybrid card.

FIG. 2 depicts an interaction diagram illustrating exchanges between the entities of FIG. 1 according to one embodiment of the invention.

As a preliminary step, the card-issuing financial institution 110 establishes 205 a credit card account 135 and an account linked to a hybrid card (“linked account”) 140 for the hybrid cardholder 105. The cardholder 105 deposits funds into the linked account 140. Contemporaneous with these events, the cardholder 105 is issued 205 a hybrid card that is capable of both credit card functionality and debit card functionality. In one embodiment, the account balance of the linked account 140 comprises available funds for the hybrid card.

In one embodiment, there are no distinguishable differences in the appearance of the hybrid card from existing credit cards. In another embodiment, the only distinguishable difference is the word “hybrid” printed in one or more places on the hybrid card. For example, the word “hybrid” replaces the word “debit” on present Visa™ and MasterCard™ branded stored-value cards according to one embodiment.

At a later time, as indicated by wavy lines, the hybrid cardholder 105 makes a purchase 210 from a merchant 115. At the point of sale, the merchant 115 calculates the amount of the purchase and asks the cardholder 105 for payment. The cardholder 105 uses the hybrid card described herein. If using the hybrid card in person, the cardholder 105 presents the merchant 115 with the hybrid card and the merchant 115 runs the hybrid card. The amount of the sale is either hand-entered or transmitted by the cash register according to various embodiments. If the transaction occurs remotely, e.g., online via a merchant 115 website, the cardholder 105 enters the card number and the card is processed by the merchant 115 according to the process provided by the website.

The cardholder 105 has two options for using the hybrid card: as a credit card or as a debit card. If the cardholder 105 uses the hybrid card as a credit card, the transaction between cardholder 105 and merchant 115 proceeds like any other credit card transaction, including signing a receipt at the conclusion of the transaction. If the cardholder 105 uses the hybrid card as a debit card, the cardholder 105 enters a personal identification number (PIN) instead of signing a sales receipt according to one embodiment. One reason a cardholder 105 might choose to enter a PIN instead of signing the sales slip is to get cash back. Getting cash back at the point of sale generally is more convenient than getting cash from the financial institution in a separate transaction, and fees that cardholders 105 pay for PIN-based transactions often are less than fees for cash advances, e.g., at an automated teller machine (ATM) using a credit card.

Next the merchant 115 transmits 215 transaction information to the processor 125. In one embodiment, the transaction information includes the card number, transaction amount, and request for authorization. If the hybrid card was used as a debit card, the transaction also includes the PIN number and the transaction amount includes the cash back amount, if any. The processor 125 begins processing 220 the transaction and routes 225 an authorization request to the card-issuing financial institution 110. In one embodiment, the card number identifies to the processor 125 the type of card, the card-issuing financial institution 110, and the cardholder's account number.

Upon receiving the request 225, the card-issuing financial institution 110 verifies 230 the transaction according to one embodiment. In one embodiment, the verification 230 process involves several steps. First, the card-issuing financial institution 110 determines whether the card is a hybrid card, e.g., by examining the card number. Next, if the card is a hybrid card, instead of checking the card's available credit (as the financial institution would do for a regular credit card), the card-issuing financial institution 110 checks the available funds in the cardholder's linked account 140 according to one embodiment. In one embodiment, if the available funds in the linked account 140 are sufficient to cover the amount of the transaction, the transaction is approved. If the available funds in the cardholder's linked account 140 are not sufficient to cover the purchase, the transaction is declined.

Then, the verification process continues with the card-issuing financial institution 110 determining whether the transaction is a credit transaction or a debit transaction. If the hybrid card was used as a credit card and the transaction is approved, the card-issuing financial institution 110 freezes the funds in the linked account 140 for the transaction amount, along with any applicable fees, however, no funds are removed from the cardholder's linked account 140 at this time in one embodiment. Thus, the card-issuing financial institution 110 extends credit to the cardholder 105 in the amount of the transaction in response to the hybrid card being used as a credit card, and removal of funds is delayed. The cardholder's available credit, or credit limit, is then, by definition, reduced by the same amount. In this example, the card-issuing financial institution 110 then generates an authorization code approving the transaction and sends 235a an authorization code (or decline, if the transaction was declined) to the processor 125.

If the hybrid card was used as a debit card, a PIN entered, and the transaction approved, the card-issuing financial institution 110 instead provides direct access to the available funds in the linked account 140. The card-issuing financial institution 110 then sends 235b the transaction funds directly to the merchant financial institution 120 from the cardholder's linked account 140 contemporaneous with approval to the merchant 115. In one embodiment, the processor 125 facilitates this exchange. Debit transactions reduce the available funds in the cardholder's linked account 140 according to one embodiment, and thus no credit is extended to the cardholder 105 for debit transactions. In one embodiment, a transaction fee typically is charged to the hybrid card cardholder 105 for debit transactions.

The processor 125 then forwards 240 the authorization code (or denial) to the merchant 115. The merchant 115 approves 245 the transaction for the cardholder 105. If the transaction takes place in person, the merchant 115 presents the cardholder with a receipt for signature according to one embodiment. As with regular credit card transactions, the cardholder's signature obligates the cardholder 105 to pay the card-issuing financial institution the amount of the sale plus any interest that may accrue in accordance with the cardholder terms and conditions. If the transaction takes place remotely, e.g., online, a signature generally is not required and the merchant 115 issues a receipt electronically according to one embodiment. In accordance with various embodiments, online merchants use other means to verify identity for credit card purchases, e.g., requesting a number printed on the back of the card.

At a later time, as indicated by the wavy line, the merchant 115 sends 250 interchange data to the processor 125. Generally, this process includes a merchant 115 reviewing all transactions for a given time period, e.g., the day's transactions. In so doing, the merchant 115 compares authorizations to signed sales drafts in one embodiment. When all transactions are matched, the merchant transmits 250 data for each authorized card transaction to each respective acquiring financial institution for deposit.

The processor 125 performs an interchange with the card-issuing financial institution 110, sending 255 the interchange data in exchange for funds. The card-issuing financial institution 110 takes 260 funds from the cardholder's credit account 135 for a credit card type of transaction, as secured by the linked account 140. The card-issuing financial institution 110 then sends 265 transaction funds to the processor 125. The transaction funds sent are reduced by an interchange fee according to one embodiment. The processor 125 then deposits 270 the funds received from the card-issuing financial institution 110 to the merchant financial institution 120. In one embodiment, the fees are reduced by the processor 125 to account for a discount fee to the processor 125.

At a later time, as indicated by the wavy line, e.g., on the hybrid card payment due date, the card-issuing financial institution 10 electronically debits 272 the linked account 140 for credit extended to the cardholder 105 during a billing period by processing 270 electronic payment for charges made via credit card transactions during the billing period, plus any unpaid fees according to one embodiment. The card-issuing financial institution 110 electronically debits the cardholder's linked account 140 to the credit card 135 account as full, on-time payment for the credit transactions according to one embodiment. This step is not necessary for debit transactions, since funds for those transactions are deducted immediately, and thus no credit is extended by the card-issuing financial institution 110.

In one embodiment, no monthly billing statement is sent to the cardholder, nor is the cardholder required to mail in a monthly payment for charges made for credit card transactions. Instead, the card-issuing financial institution 110 sends 275 a full accounting for all debit and credit card transactions to the cardholder 105, e.g., at the end of each billing period. The accounting takes place by mail or electronically according to various embodiments. This aspect of the invention is advantageous because it prevents the cardholder 105 from late or minimal payments that result in negative credit information being reported to credit bureaus 130.

In addition, the card-issuing financial institution 110 reports 280 credit information to a credit bureau 130 for credit extended to the cardholder 105 during the billing period at various intervals, e.g., monthly. The credit information includes, in one embodiment, the high credit balance and payment information. Because charges to the hybrid card (i.e., credit transaction amounts) are paid in full and on time, positive information is reported to the credit bureau 130 according to one embodiment. In addition, the cardholder 105 avoids paying interest charges and late payment fees. Pin-based (or “debit”) transactions do not result in an extension of credit according to one embodiment, and therefore these transactions are not reported to the credit bureau 130. This aspect of the invention is advantageous to the card-issuing financial institution 110 as well; because no credit is extended to cardholders 105, cardholder defaults are prevented.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

I claim:

1. A method of facilitating a hybrid card program for extending and building credit, comprising:
issuing a hybrid card to a user, the hybrid card capable of both credit card functionality and debit card functionality;
establishing an account linked to the hybrid card with an account balance comprising available funds;
extending credit to the user in response to the hybrid card being used as a credit card, wherein the available funds serve as a credit limit for the credit card functionality;
providing direct access to the available funds in response to the hybrid card being used as a debit card;
electronically debiting the account for credit extended to the user during a billing period; and
reporting to a credit bureau credit extended to the user during the billing period.

2. The method of claim 1, further comprising reducing the available funds in response to cash withdrawals and debit card transactions.

3. The method of claim 1, wherein the available funds are less than the account balance as a result of a hold on funds for credit extended.

4. The method of claim 1, wherein extending credit comprises delaying removal of funds from the account linked to the hybrid card.

5. The method of claim 1, wherein the available funds serve as security for credit extended.

6. The method of claim 1, wherein electronically debiting the account for credit extended comprises payment in full.

7. The method of claim 6, wherein reporting to a credit bureau credit extended comprises an indication of the payment in full.

8. The method of claim 1, further comprising debiting fees from the account in response to credit extended.

9. The method of claim 1, further comprising enabling direct deposit of funds to the account from third parties.

10. The method of claim 1, further comprising:
issuing a second hybrid card to a second user; and
enabling the user to transfer funds from the account to an account associated with the second hybrid card.

11. The method of claim 1, wherein the user can transfer funds form the account to an account associated with a second hybrid card.

12. The method of claim 1, further comprising accepting deposits to the account at an automated teller machine.

13. The method of claim 1, further comprising establishing a savings account linked to the hybrid card.

14. A method for processing a hybrid card transaction, comprising:
in response to receiving from a merchant information associated with a transaction, initiating processing by sending an authorization request to a financial institution, the information indicating that the transaction involves use of a hybrid card and the transaction is a credit-type transaction;
upon receiving an authorization code from the financial institution in reply to the authorization request, forwarding the authorization code to the merchant, wherein authorization is based on the financial institution having verified available funds in an account linked to the hybrid card;
in response to receiving from the merchant interchange data, exchanging with the financial institution the interchange data for interchange funds, the interchange funds including funds associated with the transaction, wherein the funds associated with the transaction reduce a credit limit associated with the hybrid card; and
depositing the interchange funds to an account associated with the merchant.

15. The method of claim 14, wherein a card number associated with the hybrid card provides the information.

16. The method of claim 14, wherein the hybrid card is issued by the financial institution.

17. The method of claim 14, wherein the account linked to the hybrid card provides security for credit extended.

18. A computer program product for facilitating a hybrid card program for extending and building credit, the computer program product comprising:
a computer-readable medium; and
computer program code, coded on the medium, comprising:
an account module for issuing a user a hybrid card capable of both credit card functionality and debit card functionality and establishing an account linked to the hybrid card with an account balance comprising available funds;
a transaction module for extending credit to the user in response to the hybrid card being used as a credit card and providing direct access to the available funds in response to the hybrid card being used as a debit card;
an accounting module for electronically debiting the account for credit extended to the user during a billing period; and
a reporting module for reporting to a credit bureau credit extended to the user during the billing period.

19. The computer program product of claim 18, further comprising computer program code, coded on the medium, for reducing the available funds in response to cash withdrawals and debit card transactions.

20. The computer program product of claim 18, wherein extending credit comprises delaying removal of funds from the account linked to the hybrid card.

21. The computer program product of claim 18, wherein the available funds serve as security for credit extended.

22. The computer program product of claim 18, wherein reporting to a credit bureau credit extended comprises an indication of the payment in full.

23. A computer program product for processing a hybrid card transaction, the computer program product comprising:
a computer-readable medium; and
computer program code, coded on the medium, comprising:
an initiate module for initiating processing of a transaction by sending an authorization request to a financial institution upon receipt of information indicating that the transaction involves use of a hybrid card and the transaction is a credit-type transaction;
an authorization module for forwarding an authorization code received from a financial institution to a merchant, wherein the authorization code is based on the financial institution having verified available funds in an account linked to the hybrid card; and
an interchange module for exchanging with the financial institution interchange data received from the merchant for interchange funds, the interchange funds including funds associated with the transaction, wherein the funds associated with the transaction reduce a credit limit associated with the hybrid card, and depositing the interchange funds to an account associated with the merchant.

24. The computer program product of claim 23, wherein a card number associated with the hybrid card provides the information.

25. The computer program product of claim 23, wherein the hybrid card is issued by the financial institution.

26. The computer program product of claim 23, wherein the account linked to the hybrid card provides security for credit extended.
